(19) United States
(12) Patent Application Publication
(10) Pub. No.: US 2001/0044831 A1
(43) Pub. Date: Nov. 22, 2001

(54) System for communicating messages

(75) Inventor: Gou Yamazaki, Tokyo (JP)

Correspondence Address: David A. Blumenthal, FOLEY & LARDNER, Washington Harbour, 3000 K Street, N.W., Suite 500, Washington, DC, 20007-5109, US

(73) Assignee: NEC CORPORATION

(21) Appl. No.: 09/859,479

(22) Filed: May 18, 2001

(30) Foreign Application Priority Data
May 19, 2000 (JP) 2000-147384

(51) Int. Cl. G06F 15/16; H04M 11/00

(52) U.S. Cl. 709/206; 379/93.24

(57) ABSTRACT

A message consignor transmits messages, recipient information regarding the intended recipients of the messages and day/hours information designating the day and hours for communicating each message to a message management site via a telephone network if an attribute of the message is voice or via the Internet if an attribute of the message is an e-mail. The message management site stores these messages, recipient information and day/hours information in association with one another, and transmits a message regarding which the day and hours designated by day/hours information associated with it have arrived via the telephone network if an attribute of the message is voice or via the Internet if an attribute of the message is an e-mail, on the basis of recipient information associated with the message. In addition, automatic conversion of a message attribute and association of a plurality of messages with one another are also accomplished.

### BACKGROUND OF THE INVENTION

1. Field of the Invention

The present invention relates to a message communicating method and a message communicating system using the Internet and a telephone network.

2. Description of the Related Art

A message, which is an indirect way of interpersonal exchange of information, can buffer the impact of direct interpersonal contact. However, public or private message boards in railway stations, public parks and other public institutions are essentially nothing to convey messages to their intended recipients without fail and, if they do at all, can do so only slowly.

On the other hand, the development of the Internet and radio communication equipment has made possible instantaneous communication of a vast quantity of messages. Demand is rising for message service allowing easy call initiation and reliable connection of the call to its intended recipient, using portable terminals such as pocket bells and mobile telephones, and also for message service with particular reliability of call reception, using stationary terminals such as personal computers (PCs)

### SUMMARY OF THE INVENTION

An object of the present invention is to provide a message communicating method and a message communicating system allowing easy call initiation and reliable communication of calls to their respective intended recipients.

Another object of the present invention is to provide a message communicating method and a message communicating system ensuring reliable arrival of calls at their respective destinations.

According to an aspect of the present invention, there is provided a system for communicating messages, comprising: a receiving device for receiving messages, recipient information regarding the intended recipients of the messages and day/hours information designating the day and hours for communicating each message via a telephone network if an attribute of the message is voice or via the Internet if an attribute of the message is an e-mail; a storage device for storing the messages, the recipient information and the day/hours information received from the receiving device, each being associated with the others; and a transmitting device for transmitting, out of the messages stored in the storage device, a message regarding which the day and hours designated by day/hours information associated with it have arrived, via a telephone network if an attribute of the message is voice or via the Internet if an attribute of the message is an e-mail on the basis of recipient information associated with the message.

Here, the receiving device may as well receive information on attributes of the intended recipients of the messages; the storage device may store the attribute information on the intended recipients received by the receiving device; and the transmitting device may transmit a message via the Internet, if an attribute of the message is voice and an attribute of the intended recipient of the message stored in the storage device is e-mail, after converting the attribute of the message into an e-mail, or via the telephone network, if the attribute of the message is e-mail and the attribute of the intended recipient of the message stored in the storage device is voice, after converting the attribute of the message into voice.

Or, the receiving device may as well receive distinguishing information for identifying another message related to the main message to be communicated; the storage device may store, in association with the main message, the distinguishing information received by the receiving device; and the transmitting device may transmit the main message together with the distinguishing information stored in the storage device in association with that message.

According to another aspect of the present invention, there is provided a method for communicating messages, comprising steps of: receiving messages, recipient information regarding the intended recipients of the messages and day/hours information designating the day and hours for communicating each message via a telephone network if an attribute of the message is voice or via the Internet if an attribute of the message is an e-mail; storing the messages, the recipient information and the day/hours information, each being associated with the others; and transmitting, out of the stored messages, a message regarding which the day and hours designated by day/hours information associated with it have arrived, via a telephone network if an attribute of the message is voice or via the Internet if an attribute of the message is an e-mail on the basis of recipient information associated with the message.

Here, at the receiving step, information on attributes of the intended recipients of the messages may as well be received; at the storing step, the attribute information on the intended recipients may be stored; and at the transmitting step, the message may be transmitted via the Internet, if an attribute of the message is voice and an attribute of the intended recipient is e-mail, after converting the attribute of the message into an e-mail, or via the telephone network, if the attribute of the message is e-mail and the attribute of the intended recipient of the message is voice, after converting the attribute of the message into voice.

Or, at the receiving step, distinguishing information for identifying another message related to the main message to be communicated may as well be received; at the storing step, the distinguishing information may be stored in association with the main message; and at the transmitting step, the main message maybe transmitted together with the distinguishing information stored in association with that message.

According to still another aspect of the present invention, there is provided a program for communicating messages, said program enabling a computer to execute: reception processing to receive messages, recipient information regarding the intended recipients of the messages and day/hours information designating the day and hours for communicating each message via a telephone network if an attribute of the message is voice or via the Internet if an attribute of the message is an e-mail; storage processing to store the message, the recipient information and the day/hours information received by the reception processing, each being associated with the others; and transmission processing to transmit, out of the messages stored by the storage processing, a message regarding which the day and hours designated by day/hours information associated with it have arrived, via a telephone network if an attribute of the message is voice or via the Internet if an attribute of the message is an e-mail on the basis of recipient information associated with the message.

Here, the reception processing may as well include processing to receive information on attributes of the intended recipients of the messages; the storage processing may include processing to store the attributes of the intended recipients received by the reception processing; and the transmission processing may include processing to transmit a message via the Internet, if an attribute of the message is voice and an attribute of the intended recipient is e-mail, after converting the attribute of the message into an e-mail, or via the telephone network, if the attribute of the message is e-mail and the attribute of the intended recipient of the message is voice, after converting the attribute of the message into voice.

Or, the reception processing may as well include processing to receive distinguishing information for identifying another message related to the main message to be communicated; the storage processing may include processing to store the distinguishing information, in association with the main message, received by the reception processing; and the transmission processing may include processing to transmit the main message together with the distinguishing information stored in association with that message by the storage processing.

### BRIEF DESCRIPTION OF THE DRAWINGS

Other features and advantages of the present invention will become more apparent from the detailed description hereunder when taken in conjunction with the accompanying drawings, wherein:

FIG. 1 illustrates the overall configuration of a preferred embodiment of the invention;

FIG. 2 is a flow chart showing the operation to register a message having a voice attribute with a message management server in the embodiment of the invention;

FIG. 3 is a flow chart showing the operation to register a message having an e-mail attribute with the message management server in the embodiment of the invention;

FIG. 4 is a flow chart showing the operation of the message management server in the embodiment of the invention to communicate a message to its intended recipient;

FIG. 5 is a flow chart showing the operation of the message management server in Embodiment (1) of the invention to communicate a message to its intended recipient;

FIG. 6 is a flow chart showing the operation to register a message having a voice attribute with the message management server in Embodiment (2) of the invention;

FIG. 7 is a flow chart showing the operation to register a message having an e-mail attribute with the message management server in Embodiment (2) of the invention; and

FIG. 8 illustrates the overall configuration of a variation of the embodiments of the invention.

### DETAILED DESCRIPTION OF THE PREFERRED EMBODIMENTS

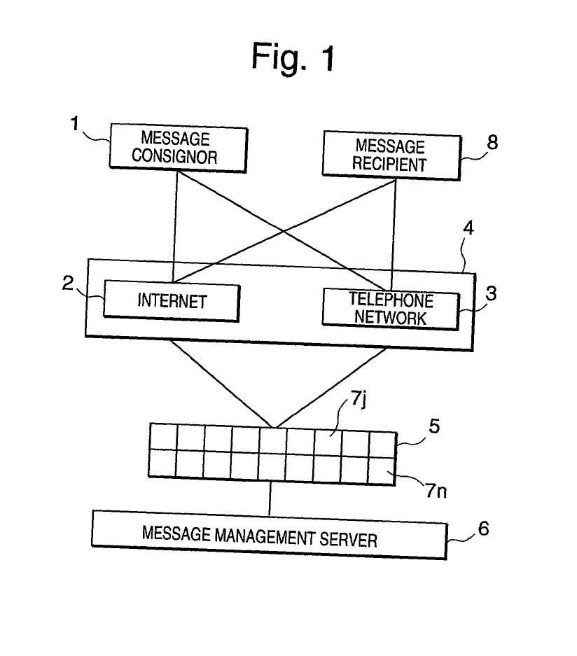

Referring to FIG. 1, in a message communication system embodying the present invention, a message consignor 1 is connected to a message management site 5 via a communication network 4 which may be the Internet 2 or a telephone network 3. A message recipient 8 is also connected to the message management site 5 via the communication network 4 which may be the Internet 2 or the telephone network 3. Further, the message management site 5 is connected to a message management server 6 for managing messages that are sent from the message consignor 1.

It is supposed here that the message consignor 1 and the message recipient 8 possess terminal units such as portable terminals or stationary terminals, and in an actual system configuration, a terminal unit possessed by the message consignor 1 and a terminal unit possessed by the message recipient 8 are connected to the communication network 4.

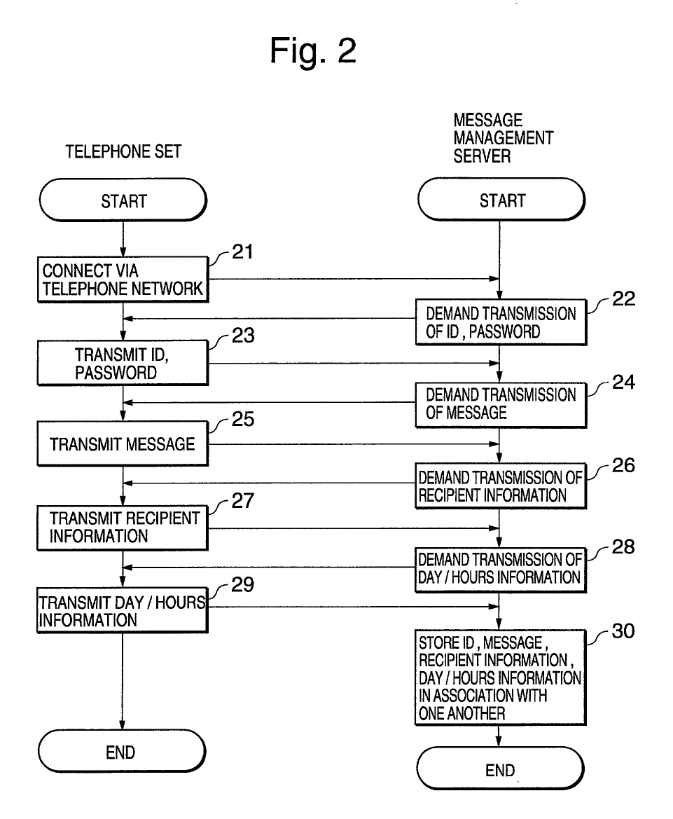

Basic operation of the message communication system according to the invention will be described below with reference to FIGS. 2 through 4.

First, the message consignor 1, to subscribe to this service, enters into a contract with a company providing this service. The service providing company owns the facilities of the message management site 5 and of the message management server 6. The message management site 5 operates a message table 7n. The message consignor 1 has a personal message table 7j of its own in the message table 7n of the message management site 5. The message consignor 1 can register messages as it desires in its already available personal message table 7j via the communication network 4.

There are two kinds of messages, voice and e-mail. The message consignor 1 selects either voice or e-mail as an attribute of its message.

FIG. 2 shows a flow of processing that takes place when the message consignor 1 selects voice to register a message.

When the message consignor 1 uses a telephone set to connect itself to the message management server 6 via the telephone network 3 (step 21), the message management server 6 demands transmission of an ID and a password (step 22). When the message consignor 1, responding to this demand, transmits the ID and the password prescribed under the contract (step 23), the message management server 6 demands transmission of a message (step 24). When the message consignor 1, responding to this demand, transmits the message (step 25), the message management server 6 demands transmission of information regarding the intended recipient of the message (step 26). When the message consignor 1, responding to this demand, transmits the recipient information (step 27), the message management server 6 demands transmission of information regarding the day and hours for communicating the message (step 28). When the message consignor 1, responding to this demand, transmits the day and hours for communicating the message (step 29), the message management server 6 associates the ID, message, recipient information and day/hours information transmitted from the message consignor 1 with one another, and stores them into the personal message table 7j of the message consignor 1 (step 30). In this case, as the equipment on the part of the intended recipient is a mobile telephone, stationary telephone or the like, the recipient information is a telephone number.

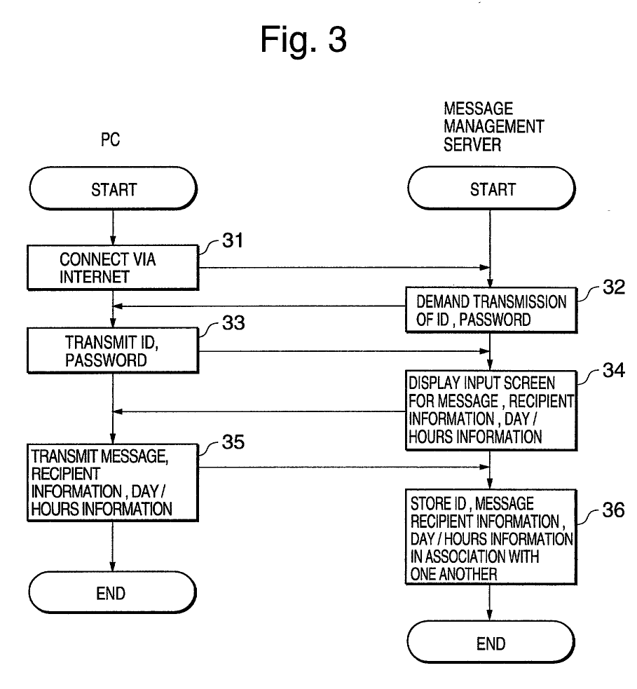

FIG. 3 shows a flow of processing that takes place when the message consignor 1 selects e-mail to register a message.

When the message consignor 1 uses a PC to connect itself to the message management server 6 via the Internet 2 (step 31), the message management server 6 demands transmission of an ID and a password (step 32). When the message consignor 1, responding to this demand, transmits the ID and the password prescribed under the contract (step 33), the message management server 6 transmits an input screen (home page) urging the message consignor 1 to enter the message, information regarding the intended recipient of the message and information regarding the day and hours for communicating the message, and displays this screen on the PC (step 34). When the message consignor 1 enters into this screen the message, recipient information and day/hours information (step 35), the message management server 6 associates the ID, message, recipient information and day/hours information transmitted from the message consignor 1 with one another, and stores them into the personal message table 7j of the message consignor 1 (step 36). In this case, as the equipment on the part of the intended recipient is a PC, a mobile telephone or a pocket bell having an e-mail receiving function or the like, the recipient information is an e-mail address.

Now, the message registered in this way will be communicated by the message management server 6 to the voice-compatible equipment of the message recipient 8 via the telephone network 3 if its attribute is voice, or to the e-mail-compatible equipment of the message recipient 8 via the Internet 2 if its attribute is e-mail.

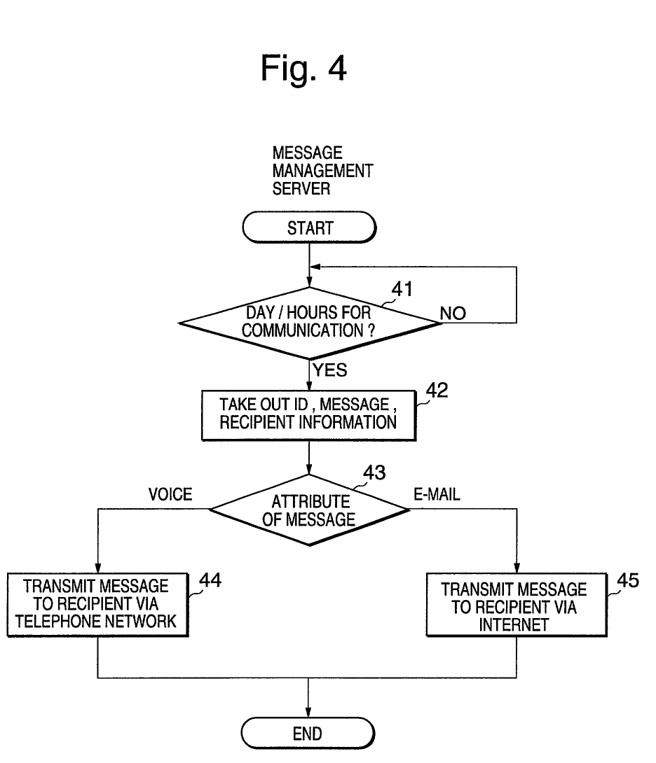

FIG. 4 shows a flow of processing that takes place then.

First, the message management server 6 checks whether or not there is any message for which the current day and hours are designated as day/hours information (step 41). If there is no such message, similar checking will be repeated or, if there is any such message, the message management server 6 will take out of the pertinent personal message table 7j the ID of the message consignor having registered the message, the message and information regarding the intended recipient of the message (step 42). Then, the message management server 6 judges whether the attribute of the message is voice or e-mail (step 43) and, if it is voice, transmits the message via the telephone network 3 to a unit whose telephone number is registered as recipient information or, if it is e-mail, transmits the message via the Internet 2 to a unit whose e-mail address is registered as recipient information. Incidentally, information on the identification of the consignor of the message can be added to the message on the basis of the ID associated with the message.

Whereas the basic operation of the message communication system according to the present invention is now completed, the message consignor 1 has to pay a fee for its use of the service to the message management service company. The payable fee may be set, for instance, as a sum of a monthly basic charge plus a pro rata sum for e-mails or telephone calls initiated from the message management site 5.

Incidentally, in such a message service, the message recipient and the message consignor need not be different persons, but the message recipient may be the message consignor itself. Thus, by utilizing a communication medium familiar to most people, such as telephone or e-mail, the service can automatically, without requiring the user to take no particular trouble, give an effective instruction or reminder to another person or the user itself in accordance with a transmission schedule of messages. This service can be useful in, for instance, notifying a schedule, making a morning call or giving a reminder.

The message service according to the present invention is characterized by its adaptability to two message attributes, voice and e-mail.

Next will be described two preferred embodiments of the invention making even more effective use of this characteristic.

(1) Automatic Conversion of Message Attribute

In this embodiment, one of “only voice receivable,” “only e-mail receivable” and “both voice and e-mail receivable” attributes is additionally registered in advance as recipient information.

The message consignor 1 registers a message in the flow of processing shown in FIG. 2 or FIG. 3 without being conscious of whether the recipient attribute is “only voice receivable,” “only e-mail receivable” or “both voice and e-mail receivable”.

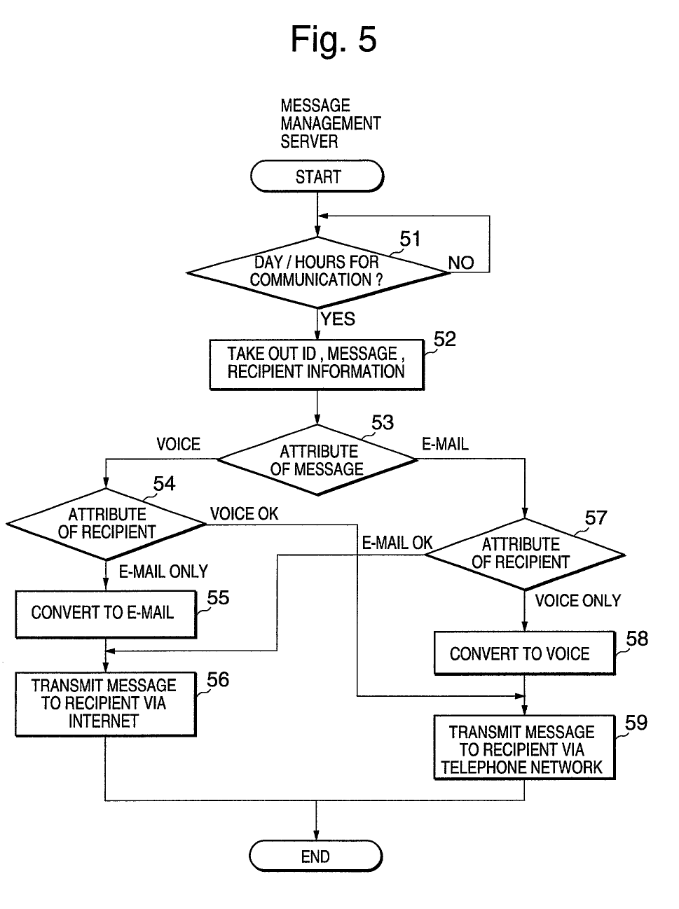

The registered message is communicated to its intended recipient in a flow of processing shown in FIG. 5.

First, the message management server 6 checks whether or not there is any message for which the current day and hours are designated as day/hours information (step 51). If there is no such message, similar checking will be repeated or, if there is any such message, the ID of the message consignor having registered the message, the message and information regarding the intended recipient of the message will be taken out of the pertinent personal message table 7j (step 52). Then, the message management server 6 judges whether the attribute of the message is voice or e-mail (step 53) and, if it is voice, will check the attribute of the intended recipient (step 54). If it is “only e-mail receivable,” the message, after being converted into an e-mail (step 55), will be communicated via the Internet 2 to a unit whose e-mail address is registered as recipient information (step 56). Or if it is either “only voice receivable” or “both voice and e-mail receivable,” the message will be transmitted as it is via the telephone network 3 to a unit whose telephone number is registered as recipient information (step 59). Or if the attribute of the message is e-mail, the attribute of the intended recipient will be checked (step 57) and, if it is “only voice receivable,” the message, after it is converted into voice (step 58), will be communicated via the telephone network 3 to a unit whose telephone number is registered as recipient information (step 59). Or if the attribute is either “only e-mail receivable” or “both voice and e-mail receivable,” the message will be transmitted as it is via the Internet 2 to a unit whose e-mail address is registered as recipient information (step 56).

This embodiment, with its function for automatic conversion between the voice attribute and the e-mail attribute, can realize a barrier-free means of interpersonal communication between visually or aurally handicapped persons and unhandicapped persons by, for instance, having an aurally handicapped person with a telephone number register in advance “only e-mail receivable” as the attribute of his or her terminal or a visually handicapped person with an e-mail address register in advance “only voice receivable” as the attribute of his or her terminal.

(2) Association of Plurality of Messages

This embodiment of the invention sends a plurality of messages, in particular a combination of a message having a voice attribute and a message having an e-mail attribute in a manner recognizable by the recipient as a series of messages.

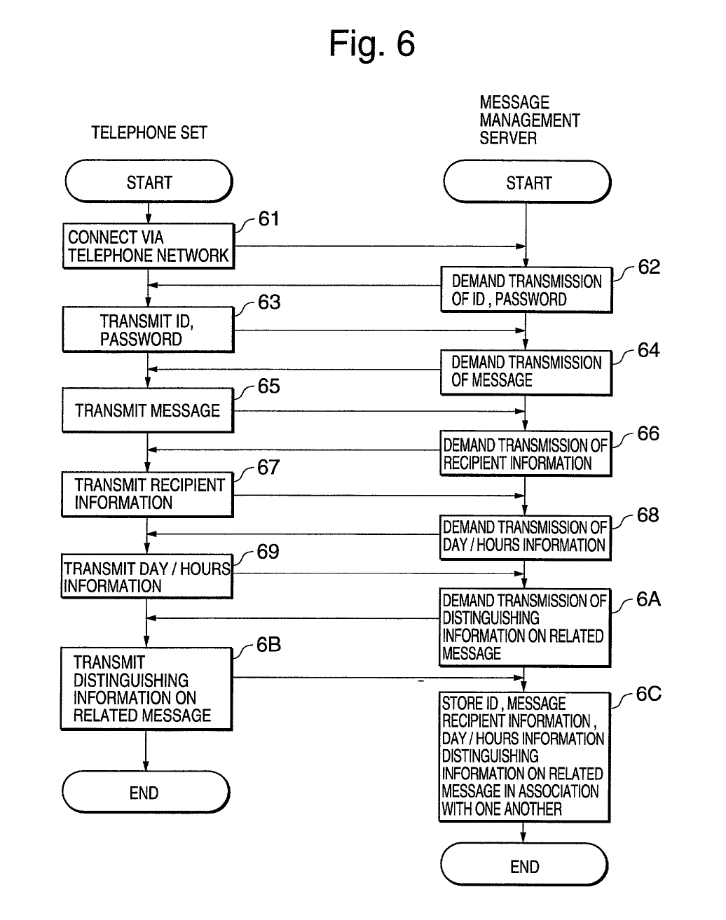

A message having a voice attribute is registered in a flow of processing shown in FIG. 6.

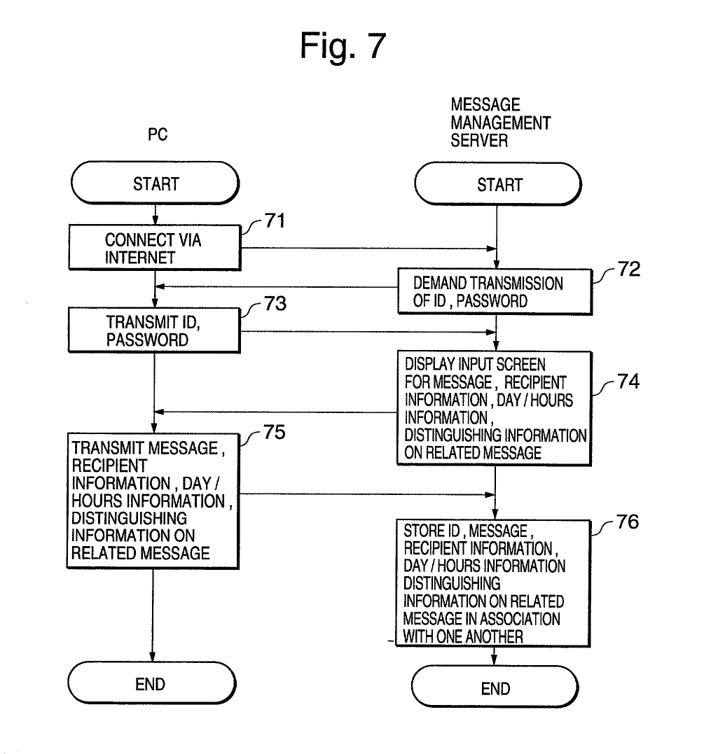

When the message consignor 1, using a telephone set, connects itself to the message management server 6 via the telephone network 3 (step 61), the message management server 6 demands transmission of an ID and a password (step 62). When the message consignor 1, responding to this demand, transmits the ID and the password prescribed under the contract (step 63), the message management server 6 demands transmission of a message (step 64). When the message consignor 1, in response to this demand, transmits a message (step 65), the message management server 6 demands transmission of information regarding the intended recipient of the message (step 66). When the message consignor 1, in response to this demand, transmits information regarding the intended recipient of the message (step 67), the message management server 6 demands transmission of information regarding the day and hours for communicating the message (step 68). When the message consignor 1, in response to this demand, transmits day/hours information (step 69), the message management server 6 demands transmission of information for distinguishing another message related to this message (step 6A). When the message consignor 1 transmits information for distinguishing another message related to the main message (step 6B), the message management server 6 associates the ID, message, recipient information, day/hours information and distinguishing information transmitted from the message consignor 1 with one another, and stores them into the personal message table 7j of the message consignor 1 (step 6C).

Where the other message related to the main message also has a voice attribute, similar registering operation is repeated in the flow of processing shown in FIG. 6. Or where the other message related to the main message has an e-mail attribute, registering operation is performed in the flow of processing shown in FIG. 7.

When the message consignor 1, using a PC, connects itself to the message management server 6 via the Internet 2 (step 71), the message management server 6 demands transmission of an ID and a password (step 72). When the message consignor 1, responding to this demand, transmits the ID and the password prescribed under the contract (step 73), the message management server 6 transmits an input screen (home page) urging the message consignor 1 to enter the message, information regarding the intended recipient of the message, information regarding the day and hours for communicating the message and information for distinguishing the other message related to the main message, and displays this screen on the PC (step 74). When the message consignor 1 enters into this screen the message, information regarding the intended recipient of the message, information regarding the day and hours for communicating the message and information for distinguishing the other message related to the main message (step 75), the message management server 6 the message management server 6 associates the ID, message, recipient information, day/hours information and information for distinguishing the other message related to the main message transmitted from the message consignor 1 with one another, and stores them into the personal message table 7j of the message consignor 1 (step 76).

Where all the plurality of messages have an e-mail attribute, similar registering operation is repeated in the flow of processing shown in FIG. 7.

As information for distinguishing the related message here, for instance, ID+X+date+serial number (X: “V” (for voice) or “M” (for e-mail) can be used, but the usable information is not limited to this combination, and anything that can assure the uniqueness of the information can be used.

Where a main message and another message related to the main message are to be communicated to the intended recipient at the same time, designation of recipient information and day/hours information for only the main message would suffice, but those for the other related message can be dispensed with. Whereas it is also possible to communicate the main message first and then to communicate the other message related to the main message in response to a simple action on this main message, designation of recipient information and day/hours information for the other related message can be dispensed with in this case, too.

On the other hand, where the main message and the other message related to the main message are to be communicated to their intended recipient at different timings and the recipient is to be notified of their mutual relevance, the day/hours information has to be designated separately for the main message and the other message related to the main message.

After that, the messages are communicated to their intended recipient in the flow of processing shown in FIG. 4. However, a message other than but related to the main message for which day/hours information is dispensed with is transmitted according to the day/hours information for the main message or when some simple action is taken on the main message according to the setting.

This embodiment makes effective communication possible by combining messages having a voice attribute and messages having an e-mail attribute. For instance, it makes possible communication of too important information to be misheard or misunderstood by a message with an e-mail attribute and communication of information involving too delicate nuance or emotion to be conveyed by this message with an e-mail attribute, such as instructions regarding the message, by a message with a voice attribute.

Even where the message and another message related to it designates the day/hours information differently, the message recipient can be notified of their constituting a series of messages.

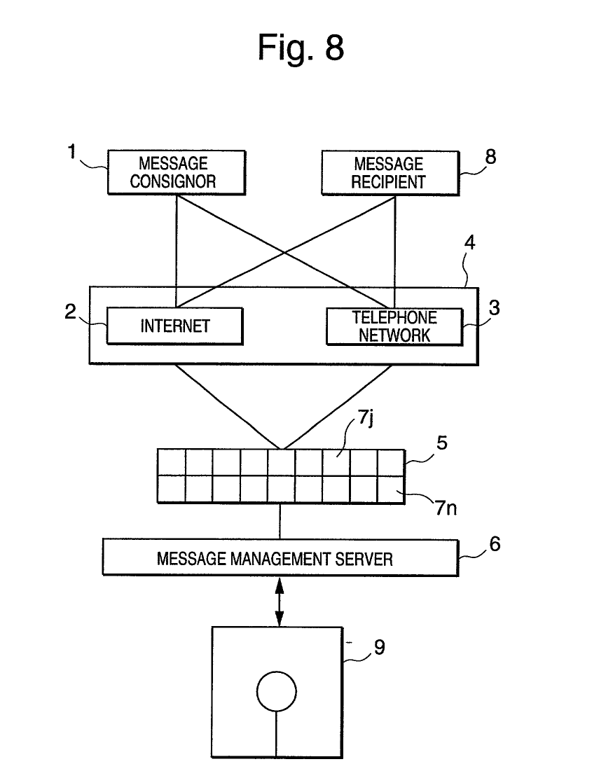

Further to refer to FIG. 8, this embodiment may include a storage medium 9 as well. The message management server 6 loads a program recorded on this storage medium 9 and, under the control of the loaded program, performs its operation as illustrated in FIGS. 2 through 7. Incidentally, the storage medium 9 may be a magnetic disk, a semiconductor memory or any other appropriate storage medium, and the program may be divided to store each divided segment on one or another of a plurality of grouped storage media. Loading of the program from the storage medium or media may be carried out via a signal line or lines.

What is claimed is:

1. A system for communicating messages, comprising:
a receiving device for receiving messages, recipient information regarding the intended recipients of the messages and day/hours information designating the day and hours for communicating each message, via a telephone network if an attribute of the message is voice or via the Internet if an attribute of the message is an e-mail;
a storage device for storing said messages, said recipient information and said day/hours information received from said receiving device, each being associated with the others; and
a transmitting device for transmitting, out of the messages stored in said storage device, a message which is associated with day/hours information designating the current day and hours, via a telephone network if an attribute of the message is voice or via said Internet if an attribute of the message is an e-mail, on the basis of recipient information associated with the message.

2. The system, as claimed in claim 1, wherein:
said receiving device receives information on attributes of the intended recipients of the messages;
said storage device stores the attribute information on said intended recipients received by said receiving device; and
said transmitting device transmits a message via the Internet, if an attribute of the message is voice and an attribute of the intended recipient of the message stored in said storage device is e-mail, after converting the attribute of the message into an e-mail, or via the telephone network, if the attribute of said message is e-mail and the attribute of the intended recipient of the message stored in said storage device is voice, after converting the attribute of the message into voice.

3. The system, as claimed in claim 1, wherein:
said receiving device receives distinguishing information for identifying another message related to said main message to be communicated;
said storage device stores, in association with said man message, said distinguishing information received by said receiving device; and
said transmitting device transmits said main message together with the distinguishing information stored in said storage device in association with that message.

4. A method for communicating messages, comprising steps of:
receiving messages, recipient information regarding the intended recipients of the messages and day/hours information designating the day and hours for communicating each message, via a telephone network if an attribute of the message is voice or via the Internet if an attribute of the message is an e-mail;
storing said messages, said recipient information and said day/hours information, each being associated with the others; and
transmitting, out of said stored messages, a message which is associated with day/hours information designating the current day and hours, via a telephone network if an attribute of the message is voice or via said Internet if an attribute of the message is an e-mail, on the basis of recipient information associated with the message.

5. The method, as claimed in claim 4, wherein:
at said receiving step, information on attributes of said intended recipients of the messages are received;
at said storing step, the attribute information on said intended recipients is stored; and
said transmitting step, the message is transmitted via the Internet, if an attribute of said message is voice and an attribute of the intended recipient is e-mail, after converting the attribute of the message into an e-mail, or via the telephone network, if the attribute of said message is e-mail and the attribute of the intended recipient of the message is voice, after converting the attribute of the message into voice.

6. The method, as claimed in claim 4, wherein:
at said receiving step, distinguishing information for identifying another message related to said main message to be communicated is received;
at said storing step, said distinguishing information is stored in association with said main message; and
at said transmitting step, said main message is transmitted together with the distinguishing information stored in association with that message.

7. A program for communicating messages, said program enabling a computer to execute:
reception processing to receive messages, recipient information regarding the intended recipients of the messages and day/hours information designating the day and hours for communicating each message, via a telephone network if an attribute of the message is voice or via the Internet if an attribute of the message is an e-mail;
storage processing to store said message, said recipient information and said day/hours information received by said reception processing, each being associated with the others; and
transmission processing to transmit, out of the messages stored by said storage processing, a message which is associated with day/hours information designating the current day and hours, via a telephone network if an attribute of the message is voice or via the Internet if an attribute of the message is an e-mail, on the basis of recipient information associated with the message.

8. The program, as claimed in claim 7, wherein:
said reception processing includes processing to receive information on attributes of said intended recipients of the messages;
said storage processing includes processing to store the attributes of said intended recipients received by said reception processing; and
said transmission processing includes processing to transmit the message via the Internet, if an attribute of said message is voice and an attribute of the intended recipient is e-mail, after converting the attribute of the message into an e-mail, or via the telephone network, if the attribute of said message is e-mail and the attribute of the intended recipient of the message is voice, after converting the attribute of the message into voice.

9. The program, as claimed in claim 7, wherein:
said reception processing includes processing to receive distinguishing information for identifying another message related to said main message to be communicated;
said storage processing includes processing to store said distinguishing information, in association with said main message, received by said reception processing; and
said transmission processing includes processing to transmit said main message together with the distinguishing information stored in association with that message by said storage processing.
